(19) United States
(12) Patent Application Publication
(10) Pub. No.: US 2006/0086047 A1
(43) Pub. Date: Apr. 27, 2006

(54) Adjustable pitch mounting bracket for lateral arm awnings

(76) Inventors: Robert G. Heitel, Laguna Beach, CA (US); Vince Weddell, Irvine, CA (US)

Correspondence Address: WALTER A. HACKLER, Ph.D.;PATENT LAW OFFICE, SUITE B, 2372 S.E. BRISTOL STREET, NEWPORT BEACH, CA, 92660-0755, US

(21) Appl. No.: 10/973,150

(22) Filed: Oct. 26, 2004

(51) Int. Cl. E05F 15/20

(52) U.S. Cl. 49/25

(57) ABSTRACT

Adjustable pitch mounting apparatus for lateral arm awnings includes a base plate fixable to a generally vertical surface along with a movable awning mounting plate fixable to an awning box. A hinge is provided and interconnects the awning mounting plate and the base plate. An actuator couples the awning mounting plate and the base plate for causing an angular relationship between the awning mounting plate and the base plate to change.

The present invention is generally related to awnings and is more particularly directed to mounting bracket apparatus for changing the pitch of a deployed awning so as to provide controlled shading from solar radiation when the sun becomes low on the horizon.

Retractable awnings are often provided on recreational vehicles, such as motor homes and motor home trailers, in order to provide additional living space by way of an outdoor area adjacent the RV. Such deployable awnings are often used in combination with vehicles having slide out portions, or sliders.

Heretofore, lateral arm awnings have been installed and adjusted for a pitch, or angle, from horizontal, at the time of installation.

While such awnings have been useful, they often fail to provide protection desired when deployed. This is particularly true when the sun is low on the horizon, such as in the late afternoon or early morning. At this time, it is desirable to be able to lower the leading edge of the awning to block the incident sun line. However, other times when the sun angle is higher in the sky, it is desirable to return the awning to a more horizontal angle.

The present invention provides for an adjustable pitch-mounting bracket, which enables pitch adjustment either automatically or remotely.

### SUMMARY OF THE INVENTION

Adjustable pitch mounting bracket apparatus in accordance with the present invention for a lateral arm awning generally includes a base plate fixable to a generally vertical surface along with a movable awning mounting plate fixable to a mounting box.

The preferred use of the present invention is on recreational vehicles with lateral arm awnings, however it may be also installed onto fixed structures such as houses and other buildings.

A hinge is provided interconnecting the awning mounting plate and the base plate. An actuator couples the awning mounting plate and a base plate and causes an angular relationship between the awning mounting plate and the base plate to change. More particularly, the actuator may include a pair of arms with a driver disposed therebetween at a position extending and retracting the arms.

In another embodiment of the present invention, the actuator includes a pair of articulated arms with a driver disposed between the articulated arms and the base plate and positioned for straightening and bending the articulated arms.

In either of the embodiments, the driver may be a linear actuator selected from a group including electric motor, hydraulic motor, and a pneumatic motor.

More particularly, the bracket apparatus may include at least one sun sensor deployable in an umbrage of an extended awning along with a controller interconnected with the sensor for operating the actuator to control the angular relationship.

In accordance with the present invention, the actuator provides a means for changing a pitch of an extended awning with respect to a horizontal by changing an angular relationship between the awning mounting plate and the base plate.

A plurality of sun sensors may be disposed in order to fine-tune the pitch of the deployed awning.

The present invention further includes a method for controlling a pitch of a deployed awning, which includes the steps of providing a bracket mounting an extendable/retractable awning to a wall and adjusting a pitch of the extending end awning with respect to the wall.

Method further includes disposing a sun sensor in an umbrage of the extended awning and operating the bracket in response to the sun sensor to control the awning pitch.

### BRIEF DESCRIPTION OF THE DRAWINGS

The advantages and features of the present invention will be better understood by the following description when considered in conjunction with the accompanying drawings in which:

FIG. 1 is a diagram of a conventional lateral arm awning disposed on a vehicle side and extending over an extended slider illustrating extended shade protection, which may be obtained by changing the pitch to accommodate for low sun angles;

FIG. 2 is a perspective view of one embodiment of the present invention of an adjustable pitch mounting bracket which includes a base plate, a movable awning mounting plate, a hinge therebetween along with an actuator coupling the awning mounting plate, and the base plate for causing an angular relationship change between the awning mounting plate and the base plate; and

FIG. 3 is a perspective view of another embodiment in accordance with the present invention illustrating an actuator, which includes a pair of articulated arms with a driver disposed between the articulated arms and a base plate at a position straightening and bending of the articulated arms.

### DETAILED DESCRIPTION

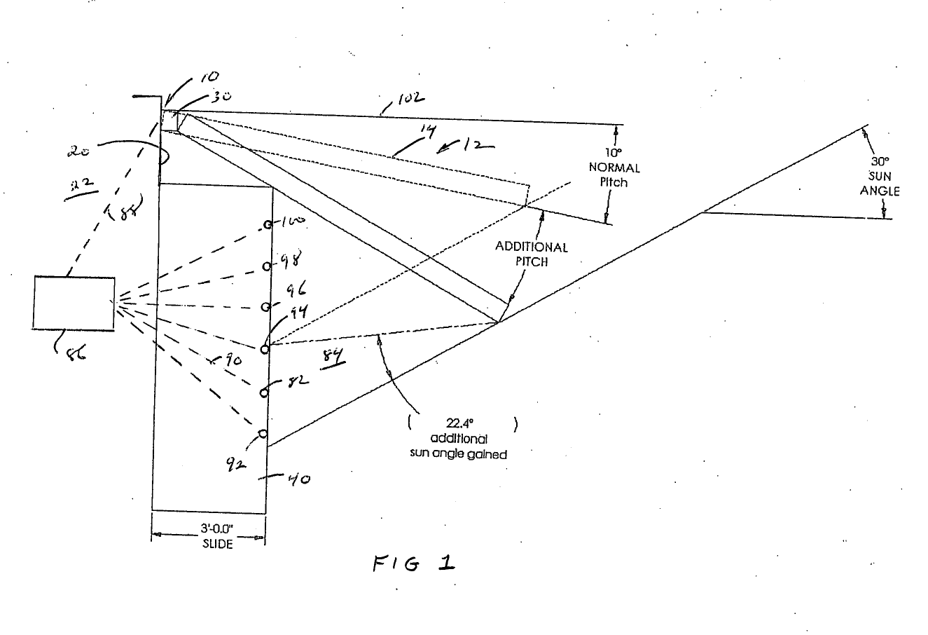

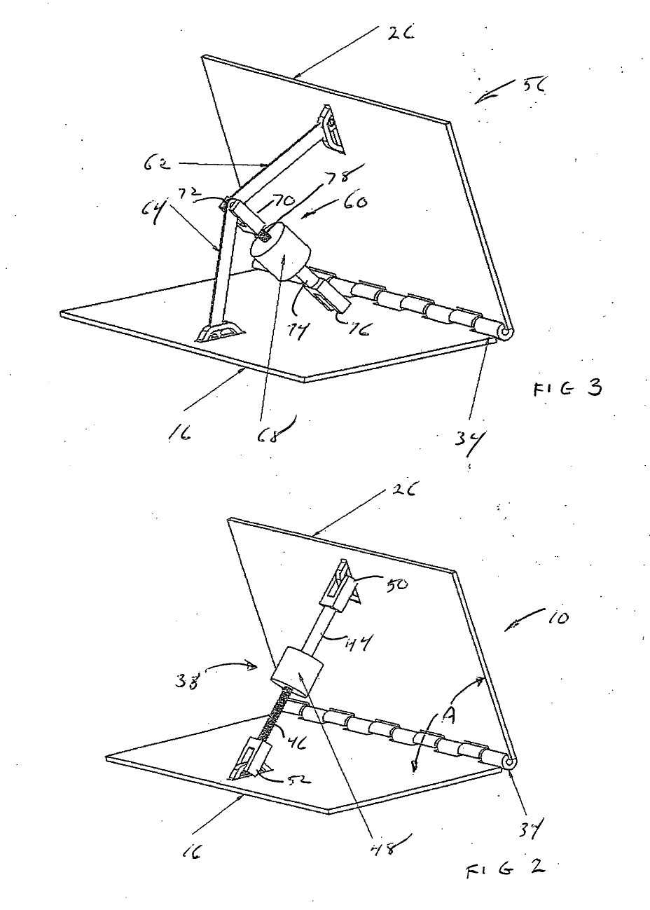

With reference to FIGS. 1 and 2, there is shown adjustable pitch mounting bracket apparatus 10 for a lateral arm awning 12 having arms 14 for retracting and deploying the awning 12 in a conventional manner, the awning 12 being shown in a deployed position in FIG. 1.

As more clearly shown in FIG. 2, the mounting bracket 10 includes a base plate 16 fixable to a generally vertical surface, such as a wall 20 of a motor home 22, see FIG. 1.

Again with reference to FIG. 2, the bracket apparatus 10 further includes a movable awning mounting plate 26 fixable to an awning box 30, see FIG. 1, in a conventional manner. A hinge 34, which may be a piano-type hinge, interconnects the awning mounting plate 26 and the base plate 16 for enabling a change in the angular relationship A, therebetween.

At least one actuator 38 couples the awning mounting plate 26 and the base plate 16 for causing an angular relationship between the awning mounting plates 26 and the base plate to change thereby effecting a pitch change as illustrated in FIG. 1. Multiple actuators 38, only one being shown, may be utilized in a spaced apart relationship between the awning mounting plate 26 of the base plate 16 depending upon a width of the awning box 10.

When multiple actuators 38, 60 are utilized between the mounting plate 26 and base plate 16, the controller 86 preferably operates the actuators 38, 60 in a coordinated manner to prevent undesirable stresses on the mounting plate 26 and base plate 16. However, it is not mandantary that each of the actuators 38, 60 be moved in an equal amount. It may be desirable to move one actuator 38 of a plurality of actuators (not shown) to gain a favorable profile in the awning.

With reference again to FIG. 1, there is shown the awning arms 14 at a 100 normal pitch and with a 300 solar attitude, a 3 meter extended awning 14 at a 36 inch extended slider 40, additional pitch is gained, as shown in FIG. 1, providing an additional 22.40 of sun angle.

With reference again to FIG. 2, the actuator 38 includes arms 44, 46 with a driver 48 disposed therebetween at a position extending and retracting the arms 44, 46.

The arm 46 may be threaded for enabling a screw type driver 48 to be utilized, alternatively the driver 48 may be a linear actuator of conventional design, which may include an electric motor, a hydraulic motor, or a pneumatic motor.

As illustrated in FIG. 2, couplings 50, 52 may be provided for accommodating the change in angular relationship between the arm 44 and a mounting plate 26 and the arm 46 and the base plate 16 respectively.

With reference to FIG. 3, there is shown an alternative embodiment bracket 26, in accordance with the present invention, with common reference characters representing identical, or substantially identical components, as hereinabove discussed in connection with the embodiment 10 shown in FIG. 2.

Returning to FIG. 3, the bracket apparatus 56 includes an actuator including articulated arms coupled to a driver 68 through an upper driver leg 70 attached at a hinged point 72 between the arms 62, 64. The driver 68 is further coupled to the base plate 16 by a leg 74 and coupling 76.

The leg may include a screw thread 76 for enabling straightening and bending of the articulated arms 62, 64 by operation of the driver 68. Alternatively, as hereinabove noted in connection with the actuator 38, the driver 48 may be a linear actuator and include either a electric motor, hydraulic motor, or a pneumatic motor.

With reference again to FIG. 1, the present invention may further include at least one sun sensor 82, of conventional design disposed in a shadow, or umbrage, of the awning 12. A controller 86 of suitable design is interconnected to the actuator 48 as indicated by the dashed line 88 and connected to the sun sensor 82, as indicated by the dash line 90 for operating the actuator 48 in order to control the angular relationship, or pitch, and depending upon the sun angle, as illustrated in FIG. 1.

Additional sensors 92-100 may be utilized for pin pointing the edge of the awning shadow 64 in order to vary the pitch of the awning 12 in small increments.

Thus the actuators 38, 60 provide a means for coupling the awning mounting plate 26 to the base plate 16 for changing the pitch of the extended awning 12 with respect to a horizontal 102 by changing an angular relationship between the awning mounting plate 26 and the base plate 16.

Accordingly, a method in accordance with the present invention for controlling a pitch of a deployable awning includes providing a bracket 10, 56 for mounting an extendable/retractable awning 12 to a wall 20 and adjusting a pitch of the extended awning 12 with respect to both the wall 20 and a horizontal 102.

Further, the method includes disposing at least one sun sensor in an umbrage of the extended awning and operating the bracket in response to the sun sensor to control the awning pitch.

Although there has been hereinabove described a specific adjustable pitch mounting bracket for lateral arm awnings in accordance with the present invention for the purpose of illustrating the manner in which the invention may be used to advantage, it should be appreciated that the invention is not limited thereto. That is, the present invention may suitably comprise, consist of, or consist essentially of the recited elements. Further, the invention illustratively disclosed herein suitably may be practiced in the absence of any element, which is not specifically disclosed herein. Accordingly, any and all modifications, variations or equivalent arrangements which may occur to those skilled in the art, should be considered to be within the scope of the present invention as defined in the appended claims.

What is claimed is:

1. Adjustable pitch mounting bracket apparatus for lateral arm awnings, the bracket apparatus comprising:
a base plate fixable to a generally vertical surface;
a movable awning mounting plate fixable to an awning box;
a hinge interconnecting the awning mounting plate and said base plate; and
an actuator coupling the awning mounting plate and said base plate and causing an angular relationship between the awning mounting plate and said base plate to change.

2. The bracket apparatus according to claim 1 wherein said actuator includes a pair of arms with a driver disposed therebetween at a position extending and retracting the arms.

3. The bracket apparatus according to claim 2 wherein said driver is a linear actuator.

4. The bracket apparatus according to claim 2 wherein said driver is selected from a group consisting of an electric motor, a hydraulic motor and a pneumatic motor.

5. The bracket apparatus according to claim 1 wherein said actuator includes a pair of articulated arms with a driver disposed between the articulated arms and said base plate at a position straightening and bending the articulated arms.

6. The bracket apparatus according to claim 5 wherein said driver is a linear actuator.

7. The bracket apparatus according to claim 5 wherein said driver includes a motor selected from a group consisting of electrical motor, a hydraulic motor and a pneumatic motor.

8. The bracket apparatus according to claim 1 further comprising at least one sun sensor deployable in an umbrage of an extended awning and a controller interconnected with the sensor and operating said actuator to control the angular relationship.

9. The brake apparatus according to claim 8 further comprises a plurality of vertically aligned sun sensors interconnected with said controller.

10. Adjustable mounting bracket for lateral arm awnings, the bracket apparatus comprising:
a base plate fixable to a generally vertical surface;
a moveable awning mounting plate fixable to an awning box;
a hinge interconnecting the awning mounting plate and said base plate; and
actuator means, coupling the awning mounting plate and said base plate, for changing a pitch of an extended awning with respect to a horizontal by charging an angular relationship between the awning mounting plate and said base plate.

11. The bracket apparatus according to claim 6 wherein said actuator means includes a pair of arms with an actuator disposed therebetween at a position extending and retracting the arms.

12. The bracket apparatus according to claim 11 wherein said actuator is a linear actuator.

13. The bracket apparatus according to claim 11 wherein said actuator includes a motor selected from a group consisting of an electrical motor, a hydraulic motor, and a pneumatic motor.

14. The bracket apparatus according to claim 10 wherein said actuator means includes a pair of articulated arms with a driver disposed between the articulating and said base plate at a position straightening and bending the articulated arms.

15. The bracket apparatus according to claim 14 wherein said driver is a linear actuator.

16. The bracket apparatus according to claim 14 wherein said driver includes a motor selected from a group consisting of an electric motor, a hydraulic motor, and a pneumatic motor.

17. The bracket apparatus according to claim 10 further comprises at least one sun sensor deployable in a umbrage of an extended awning and controller means interconnected with the sensor for operating said actuator to control the awning pitch.

18. The bracket apparatus according to claim 17 further comprising a plurality of vertically aligned sun sensors interconnecting with said controller.

19. A method for controlling a pitch of a deployed awning, said method comprising:
providing a bracket mounting an extendable/retractable awning to a wall and adjusting a pitch of an extended awning with respect to the wall;
disposing a sun sensor in an umbrage of the extended awning; and
operating said bracket in response to said sun sensor to control the awning pitch.
